(19) United States
(12) Patent Application Publication
(10) Pub. No.: US 2007/0078643 A1
(43) Pub. Date: Apr. 5, 2007

(54) Method for formation of domain-specific grammar from subspecified grammar

(76) Inventors: Célestin Sedogbo, Beynes (FR); Benedicte Goujon, Vanves (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/580,343

(22) PCT Filed: Nov. 24, 2004
(86) PCT No.: PCT/EP04/53083

§ 371 Date: May 25, 2006

(30) Foreign Application Priority Data
Nov. 25, 2003 (FR) 03 123819

(51) Int. Cl. G06F 17/27

(52) U.S. Cl. 704/9

(57) ABSTRACT

The method of the present invention is a method of designing a semantic grammar, that is to say one relating to a domain of application on the basis of a generic grammar and of a lexical knowledge base of the domain of application considered. The generic grammar is a grammar of unification grammar type with usual morpho-syntactic features (such as gender and number for the substantives or adjectives employed), and the semantic model of the domain describes the syntactico-semantic features specific to the domain of application. According to the invention a specific conceptual model of the domain concerned is established, this conceptual model is combined with a generic grammar and a generic lexicon and the specific grammar is deduced therefrom. Such a method is implemented for example to ensure the automated control of a process or of a vehicle.

The present invention pertains to a method of formulating a grammar specific to a domain on the basis of an under-specified grammar, that is to say a generic grammar containing rules for constructing sentences and constraints linking the elements of these sentences, but not containing terminology relating to a determined application.

The method of the present invention is a method of designing a semantic grammar, that is to say one relating to a domain of application on the basis of a generic grammar and of a lexical knowledge base of the domain of application considered. The generic grammar is a grammar of unification grammar type with usual morpho-syntactic features (such as gender and number for the substantives or adjectives employed), and the semantic model of the domain describes the syntactico-semantic features specific to the domain of application.

Such a method is implemented for example to ensure the automated control of a process or of a vehicle. There exist known methods describing all the sentences of a grammar, in all their grammatical forms, for a single domain of application at a time. The grammar thus described may not be reused for another domain of application, for which practically the whole grammar must be reconstructed.

The present invention is aimed at a method of formulating a semantic grammar on the basis of an (under-specified) generic grammar, this semantic grammar being able to be easily reused in any other domain of application, with the minimum possible of modifications.

The method in accordance with the invention is a method of formulating a grammar specific to a domain on the basis of a generic lexicon and of a generic grammar, and it is characterized in that a specific conceptual model of the domain concerned is established, in that this conceptual model is combined with a generic grammar and a generic lexicon and that the specific grammar is deduced therefrom. The combination consists in applying constraints of the conceptual model at one and the same time to the generic grammar and to the generic lexicon.

The present invention will be better understood on reading the detailed description of a mode of implementation, taken by way of nonlimiting example.

The method of the invention effects the separation between generic knowledge and knowledge specific to an application. The knowledge related to the domain of application is contained in the conceptual model of the application, which is seen as a set of entities and a set of relationships between these entities. The generic knowledge is found in the generic grammar, which is described as a set of syntactic and semantic rules with conceptual constraints (such as permitted relationships between an adjective and the noun to which it refers) and a morphological lexicon (which for example comprises all the conjugated forms of a verb). An exemplary conceptual constraint could be the color of an assault tank. This color can be gray, but not pink.

The conceptual model of the application contains entities, relationships between entities and associations between entities. Generally, the entities are assigned to nouns, proper nouns and adjectives. The relationships between entities can be for example: a property (a color is a property of a physical object), a part of something (for example, a wheel is a part of a bicycle), a possession (Pierre has a bicycle), a heritage (a bicycle is a terrestrial vehicle, and as such, possesses the properties of terrestrial vehicles, for example wheels). The associations are linked to the verbs and reflect their functional structure. The generic lexicon contains features not dependent on an application (gender, number, person, etc.). Coupled to the conceptual model of the application, the generic lexicon makes it possible to deliver a lexicon specific to the domain of application considered. The generic grammar is a unification grammar containing a set of syntactic and semantic rules having under-specified conceptual constraints. Coupled to the conceptual model, this grammar makes it possible to obtain a grammar specific to the domain considered.

The method of the invention will now be explained with reference to the very simplified example of a grammar describing a television programme. Table 1 below presents the conceptual model associated with this domain of application. In this table, so as to differentiate the elements of the meta-language from their contents, the elements of the meta-language are written in bold italics, and the contents in normal font.

TABLE 1

| | |
|---|---|
| Entity ([channel, [TF1, | Property (programme, category). |
| France 2]]). | |
| Entity ([film, [film]]). | Property (programme, duration). |
| Entity ([programme, | Is a (film, programme). |
| [programme]]). | |
| Entity ([category, [violent, | Is a (cartoon, programme) |
| non-violent]]). | |

Structure_functional ([show, Subject (channel), ObjetDirect
(programme), [show]]).

In this simplified table of conceptual model, the first concept description indicates that “channel” is an entity linked to the words “TF1” and “France2”, and so on and so forth for the other entities. “Property” describes the properties allocated to the corresponding entities. The last row of the table is a functional structure rule which indicates that the relationship “show” has an entity subject which is “channel”, an entity ObjetDirect (or direct object) which is “programme” and is assigned to the word “show”.

The conceptual model encodes detailed linguistic knowledge on the objects of the domain of application. Moreover, implicit linguistic transformations are used to optimize the definition of relationships between objects. For example, we define derived conceptual primitives such as:
Qualifier (E, A):—entity (E), property (E, A)
Qualifier (E, A):—is a (E, H), qualifier (H, A)

In these primitives, E is an entity, A a property and H another entity. In the first primitive, E is for example the entity “programme”, A is a programme category and in the second, the entity E is a film, H a programme and A a category.

On the basis of a generic lexicon and of the conceptual model, a specific lexicon of the domain in question is derived. Given that each entity or relationship is related to its lexical form, the general lexicon is enhanced with the constraints imposed by the conceptual model.

By assuming that the conceptual model points at valid lexemes (entries of the generic lexicon), the lexicon of the domain of application can be generated on the basis of the generic lexicon, as shown in a simplified manner in table 2 below.

TABLE 2

| | |
|---|---|
| A → det | film→noun_film |
| [gender masc] | [gender masc] |
| [number sing] | [number sing.] |
| violent→ adj_category | non-violent→ adj_category |

| | |
|---|---|
| [gender masc] | [gender masc] |
| [number sing] | [number sing.] |

show→ verb_show

```
  [number sing]
  [pers, third]
```

In this table 2, the arrows indicate the grammatical category of each of the entries of the lexicon, for example, “a” is a determiner, “non-violent” is an adjective of category type, etc. The expressions between square brackets indicate the morpho-syntactic features (gender and number) of the lexemes.

An extract of the generic grammar presenting noun groups will now be described with reference to table 3 below.

TABLE 3

```
np → det noun adj
  [ gender np] = [gender noun]
  [gender det] = [gender noun]
  [gender adj] = [gender noun]
  [number np] = [number noun]
  [number det] = [number noun]
  [number adj] = [number noun]
  [type np] = E1
  [type noun] = E1
  [type adj] = E2
  { qualifier (E1, E2) }
```

In this table 3, constituting a grammar rule, the first six constraints are related to the lexicon used, and the last four are constraints related to the conceptual model. E1 and E2 are entities, in the same way as in table 2, and np is a noun group. The square brackets surround the conceptual constraints. The rules presented in this table show that there is a conceptual constraint between the adjective (adj), the noun and the determiner (det), and that this constraint is independent of the instance of the domain of application.

Table 4 below describes generic rules which are added so as to take account of the construction of sentences.

TABLE 4

| | |
|---|---|
| s → np vp | vp → verb np |
| [number np] = [number vp] | [type vp] = [verb type] |
| [type vp] = V | [number vp] = [number verb] |
| [type np] = S | [type np] = O |

| | |
|---|---|
| {structure_functional (F) | { structure_functional (F) |

| | |
|---|---|
| type (F) = V | type (F) = V |
| subject (F) = S} | ObjetDirect (F) = O } |

In this table, np is a noun group, vp is a verb group, V the type of the verb, S the type of the subject noun group, O the type of the ObjetDirect noun group (direct object) and F is the functional structure of the sentence to be constructed. Returning to the example of table 1, we see that in the last row of this table (representing the functional structure F), V is the verb “show”, S is the entity “channel”, and 0 is the entity “programme”.

On the basis of the conceptual model (table 1) and of the lexicon of the domain considered (table 2), the extracts of the generic grammar rules describing the noun groups are combined so as to obtain the syntactico-semantic rule exhibited in a simplified manner in table 5 below. This rule depends on the domain considered.

TABLE 5

| | |
|---|---|
| np_film → det noun_film adj_category | adj_category |
| | (violent) |
| [gender np_film] = [gender noun_film] | adj_category |
| | (non violent) |
| [gender det] = [gender noun_film] | noun_film (film) |
| [gender adj_category] = [gender noun_film] | |
| [number np_film] = [number noun_film] | |
| [number det ] = [number noun_film }] | |
| [number adj_category] = [number noun_film] | |

The grammar thus obtained permits noun groups (syntagmas) such as “a violent film” or “a non-violent film”, since the predicate “qualifier” allows “category” to be a modifier of “film” in the application considered.

In the same way, the following rules, presented in a simplified manner in table 6 below, are generated on the basis of the conceptual model, of the generic lexicon and of the generic grammar of sentences.

TABLE 6

| | |
|---|---|
| s → np_channel vp_show | np_film → det noun_film adj_category |
| [number np_channel] = [number vp_show] | [gender np_film] = [gender noun_film] |

[gender det] = [gender noun_film]

| | |
|---|---|
| vp_show → verb_show np_film | [gender adj_category] = [gender |
| noun_film] | |

| [number vp_show] = [number verb_show] | [number np_film] = [number noun_film] |
|---|---|
| | [number det] = [number noun_film] |
| | [number adj_category]=[number noun_film] |

The complete grammar thus formulated (including a rule making it possible to process proper nouns) permits the following sentence: “TF1 is showing a non-violent film”.

In conclusion, the method of the invention presents the following advantages. It rests upon the separation between purely grammatical constraints and semantic and conceptual constraints, thereby making it possible to reuse purely grammatical parts upon a change of application. It makes it possible to adapt a grammar with the aid of the conceptual constraints of the domain of application. It also allows the automatic generation of the syntactico-semantic rules which are dependent on the application.

Moreover, the conceptual constraints are sufficiently simple to be entered by non-linguist experts. The conceptual information can also benefit the other levels of natural language understanding, that is to say contextual interpretation and, in part, the level of contextual interaction.

1. A method of formulating a grammar specific to a domain on the basis of an under-specified grammar, using a generic lexicon and a generic grammar, characterized in that:
a lexical knowledge base of the domain of application is constructed,
relationships and associations are established between the entities of the knowledge base,
a conceptual model is constructed on the basis of the entities, the relationships between entities and the associations between entities,
the conceptual model is combined with a generic grammar and a generic lexicon,
a grammar specific to the domain considered is produced on the basis of this combination.

2. The method as claimed in claim 1, characterized in that the combination consists in applying constraints of the conceptual model at one and the same time to the generic grammar and to the generic lexicon.

3. The method as claimed in claim 1 or 2, characterized in that it automatically produces syntactico-semantic rules dependent on the application.

4. The method as claimed in one of the preceding claims, characterized in that upon a change of application, purely grammatical parts are reused.
